(19) United States
(12) Patent Application Publication
(10) Pub. No.: US 2025/0384112 A1
(43) Pub. Date: Dec. 18, 2025

(54) IMAGE CAPTURING APPARATUS, CONTROL METHOD OF IMAGE CAPTURING APPARATUS, AND STORAGE MEDIUM

(71) Applicant: CANON KABUSHIKI KAISHA, Tokyo (JP)

(72) Inventor: Kosuke SAITO, Tokyo (JP)

(21) Appl. No.: 19/230,576

(22) Filed: Jun. 6, 2025

(30) Foreign Application Priority Data
Jun. 13, 2024 (JP) 2024-096247

(51) Int. Cl. G06F 21/31; G06V 10/74; G06V 40/12; G06V 40/16; G06V 40/18; G06V 40/70; H04N 23/611; H04N 23/62

(52) U.S. Cl. CPC G06F 21/31; G06V 10/74; G06V 40/1371; G06V 40/172; G06V 40/197; G06V 40/70; H04N 23/611; H04N 23/62

(57) ABSTRACT

An image capturing apparatus is provided comprising a sensing unit that senses a position or a state of a photographer; an authentication unit that authenticates the photographer by any one of a plurality of authentication methods each having at least one authentication accuracy; an authentication unit selection unit that selects any one of the plurality of authentication methods to be used by the authentication unit based on a position or a state of the photographer sensed by the sensing unit; and an execution unit that executes a specific process based on an authentication state of an authentication method selected by the authentication unit selection unit.

### BACKGROUND

### Technical Field

The present disclosure relates to an image capturing apparatus, a control method of the image capturing apparatus, and a storage medium.

### Description of the Related Art

Conventionally, there are units of performing personal authentication to identify a user (photographer) of an image capturing apparatus. For example, Japanese Patent Application Laid-Open No. 2024-002562 discloses a method of performing personal authentication by capturing an eye image of a user when the user looks into a viewfinder. Japanese Patent Application Laid-Open No. 2018-191194 discloses a method of identifying an individual based on biometric information of a photographer during image capture of moving images and detecting when the photographer has changed.

As personal authentication units, Japanese Patent Laid-Open No. 2024-002562 and Japanese Patent Laid-Open No. 2018-191194 disclose a plurality of candidate units such as fingerprint authentication and iris authentication. In contrast, appropriate authentication units differ depending on the situation. For example, when a moving image is captured while viewing a rear display, iris authentication performed by looking through a finder is not suitable. Additionally, an authentication unit via smartphone operation may not be fast enough when immediate image capture is required. The conventional method has not considered the use of different biometric authentication units, and there was a problem in that authentication could not be performed when authentication was desired.

The present disclosure has been made in view of the above-described points, and an object thereof is to provide an image capturing apparatus in which personal authentication is improved.

### SUMMARY

An image capturing apparatus of one embodiment of the present disclosure comprising: a sensing unit that senses a position or a state of a photographer; an authentication unit that authenticates the photographer by any one of a plurality of authentication methods each having at least one authentication accuracy; an authentication unit selection unit that selects any one of the plurality of authentication methods to be used by the authentication unit based on a position or a state of the photographer sensed by the sensing unit; and an execution unit that executes a specific process based on an authentication state of an authentication method selected by the authentication unit selection unit.

Further features of the present disclosure will become apparent from the following description of exemplary embodiments (with reference to the attached drawings).

### BRIEF DESCRIPTION OF THE DRAWINGS

FIGS. 1A and 1B are external view of a camera according to the first embodiment.

FIG. 2 is a cross-sectional view of the camera according to the first embodiment.

FIG. 3 is a block diagram of the electrical configuration of the camera according to the first embodiment.

FIG. 4 is a functional block diagram of the camera according to the first embodiment.

FIG. 5 is a flowchart for selecting an authentication unit according to the first embodiment.

FIG. 6 is an explanatory view of an authentication unit and the ease of authentication according to the first embodiment.

FIG. 7 is a functional block diagram of a camera according to the second embodiment.

FIG. 8 is a flowchart for selecting an authentication unit according to the second embodiment.

FIG. 9 is a flowchart for selecting an authentication unit according to the second embodiment.

FIG. 10 is a flowchart for selecting an authentication unit according to the second embodiment.

FIG. 11 is a functional block diagram of a camera according to the third embodiment.

### DESCRIPTION OF THE EMBODIMENTS

Hereinafter, embodiments of the present disclosure will be explained with reference to the drawings. Note that the following embodiments are not intended to limit the present disclosure according to the scope of the claims, and not all combinations of features explained in the embodiments are necessarily essential to the solution of the present disclosure.

### First Embodiment

### [Configuration Diagram of Camera]

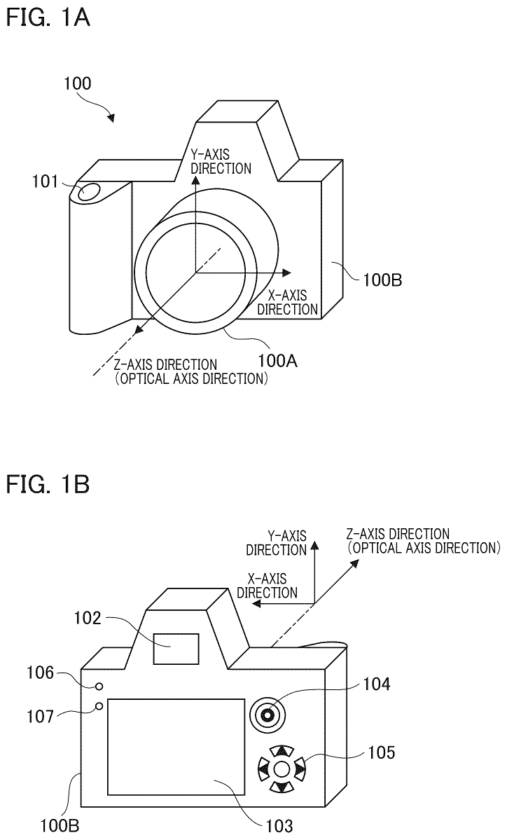

FIG. 1 is an external view of a camera according to a first embodiment. A camera 100 according to the present embodiment is a digital still camera. Additionally, the camera 100 is an interchangeable-lens camera. The camera 100 is an example of an image capturing apparatus. FIG. 1A is a front perspective view of the camera 100. FIG. 1B is a rear perspective view of the camera 100. In the following explanation, a Z-axis direction is an optical axis direction of the camera 100 as illustrated in FIG. 1A. An X-axis direction is a direction orthogonal to the Z-axis direction and is a right and left direction in FIG. 1A. A Y-axis direction is a direction orthogonal to the Z-axis direction and is the upper and lower direction in FIG. 1A.

As shown in FIG. 1A, the camera 100 includes an imaging lens unit 100A and a camera housing 100B. A release button 101, which is an operation member that receives an image capturing operation from a user (photographer), is disposed on the camera housing 100B.

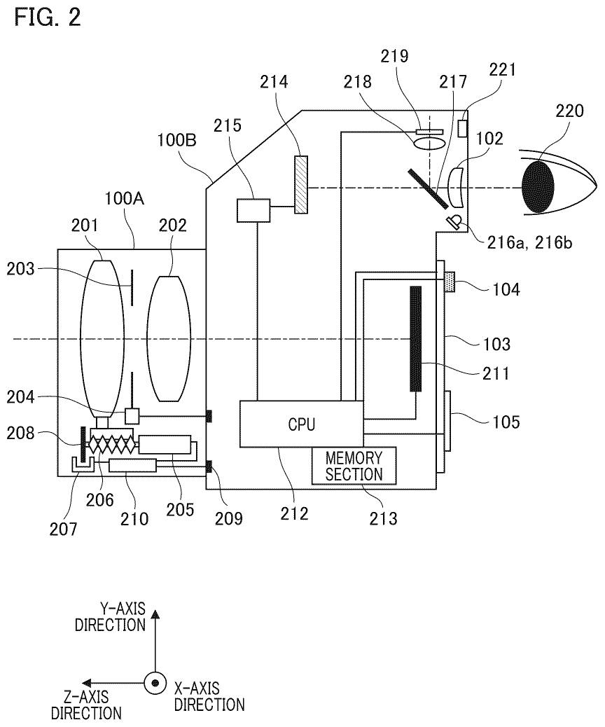

As shown in FIG. 1B, an eyepiece lens 102 into which the user looks to see a display device 214 (see FIG. 2) included in the camera housing side 100B is disposed on the back surface of the camera housing 100B. The display device 214 is an example of a display panel. The eyepiece lens 102 is an example of a finder.

Additionally, operation members 103, 104, and 105 that receive various operations from the user are also arranged on the back surface of the camera housing 100B. For example, the operation member 103 is a touch panel that receives a touch operation. For example, the operation member 104 is an operation lever that can be pushed down in each direction. For example, the operation member 105 is a four-direction key that can be pressed in each of four directions. The operation member 103, which is a touch panel, includes a display panel and has a function of displaying an image on the display panel. The display panel is, for example, a liquid crystal panel.

Furthermore, on the back surface of the camera housing 100B, a front-facing camera 106 that captures an image of the back surface side of the camera housing 100B and a microphone 107 that converts ambient sound into a sound signal that is an electric signal are also arranged.

FIG. 2 is a side cross-sectional view illustrating the camera 100 taken along a plane that is orthogonal to the X axis illustrated in FIG. 1A, is a YZ plane formed by the Y axis and the Z axis, and passes through the optical axis, and is a diagram illustrating a rough internal configuration of the camera 100.

The photographic lens unit 100A includes two lenses 201 and 202, a diaphragm 203, a diaphragm drive unit 204, a lens drive motor 205, a lens drive member 206, a photocoupler 207, a pulse plate 208, mount contacts 209, and a focus adjustment circuit 210.

The lens drive member 206 includes a drive gear that drives the lens 201 by the rotation of the drive motor 205. The photocoupler 207 detects the rotation of the pulse plate 208 in conjunction with the lens drive member 206, and transmits the detected rotation to the focus adjustment circuit 210. The focus adjustment circuit 210 drives the lens drive motor 205 based on information from the photocoupler 207 and information from the camera housing 100B (information regarding the lens drive amount), and changes the in-focus position by moving the lens 201. The mount contacts 209 are an interface between the photographic lens unit 100A and the camera housing 100B. Note that, in the present embodiment, although the two lenses 201 and 202 are shown for simplicity, in actuality, more than two lenses are included in the photographing lens unit 100A.

The camera housing 100B includes an image capture element 211, a CPU 212, a memory unit 213, the display device 214, and a display device drive circuit 215. CPU is an abbreviation for “Central Processing Unit”.

The image capture element 211 is disposed on a predetermined imaging surface of the photographing lens unit 100A. The CPU 212 is the central processing unit of a microcomputer, and controls the entire camera 100 by, for example, executing a program stored in the memory unit 213. The memory unit 213 stores a variety of information. For example, the memory unit 213 stores an image captured by the image capture element 211.

The display device 214 displays a variety of information on a screen (display surface) of the display device 214. For example, the display device 214 is a liquid crystal panel, and displays a captured image (subject image) on a screen. The display device drive circuit 215 drives the display device 214. The user can view the screen of the display device 214 through the eyepiece lens 102.

The camera housing 100B also includes light sources 216a and 216b, an optical separator 217, a light receiving lens 218, and an eye image capture element 219. The light sources 216a and 216b are light sources for illuminating an eyeball 220 of the user looking into the finder (eyepiece lens 102). The light sources 216a and 216b are light sources that have been conventionally used in single-lens reflex cameras in order to detect a line of sight based on the relationship between a reflection image by corneal reflection of light (corneal reflection image) and a pupil.

The light sources 216a and 216b are, for example, infrared light emitting diodes that emit infrared light that is imperceptible to the user, and are arranged around the eyepiece lens 102. An optical image of the eyeball 220 illuminated by the light sources 216a and 216b passes through the eyepiece lens 102 and is split into reflection light and transmission light by the optical separator 217. An eye optical image, which is an optical image of the eyeball 220 illuminated by the light sources 216a and 216b, is an optical image formed by light emitted from the light sources 216a and 216b and reflected by the eyeball 220.

The eye optical image reflected by the optical separator 217 is formed on the eye image capture element 219 in which a plurality of photoelectric conversion elements (for example, CCD or CMOS) are two dimensionally arranged by the light receiving lens 218. CCD is an abbreviation for “Charge Coupled Device”. CMOS is an abbreviation for “Complementary Metal-Oxide-Semiconductor”. The light receiving lens 218 positions the pupil of the eyeball 220 and eye image capture element 219 in a conjugate image forming relation. By line-of-sight detection processing to be described below, the line of sight of the eyeball 220 is detected from the position of the corneal reflection image in the eye optical image formed on the eye image capture element 219. As the information regarding the line of sight, for example, at least one of information indicating the line-of-sight direction (the direction of the line of sight) and information indicating the viewpoint (the position to which the line of sight is directed) on the screen of the display device 214 is obtained. The viewpoint can also be considered as a position at which the user is looking or a line-of-sight position.

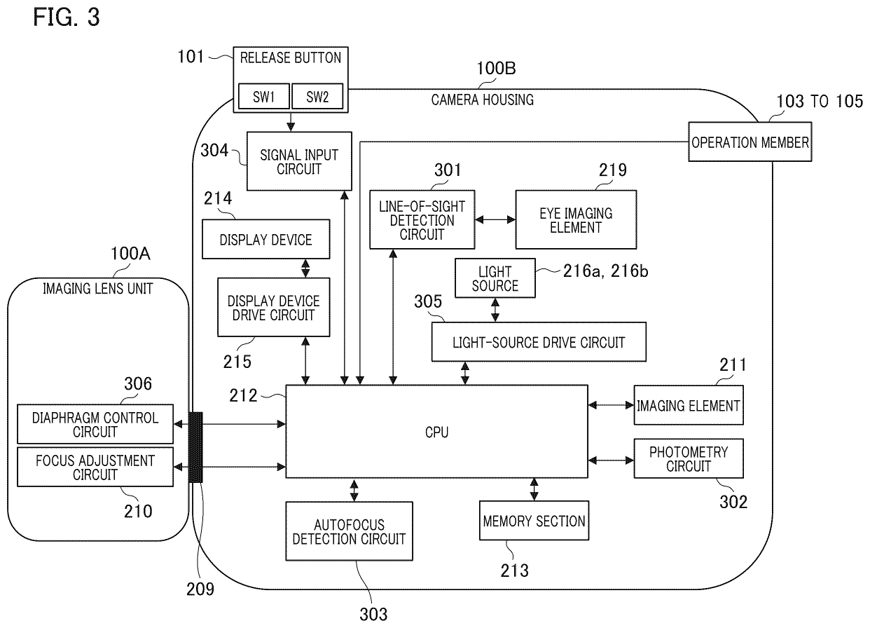

FIG. 3 is a block diagram illustrating an electrical configuration of the camera 100. The camera housing 100B includes a line-of-sight detection circuit 301, a photometry circuit 302, an automatic focus detection circuit 303, a signal input circuit 304, and a light-source drive circuit 305. The line-of-sight detection circuit 301, the photometry circuit 302, the autofocus detection circuit 303, the signal input circuit 304, the display device drive circuit 215, and the light-source drive circuit 305 are connected to the CPU 212.

The CPU 212 transmits a signal to the focus adjustment circuit 210 disposed in the photographing lens unit 100A and a diaphragm control circuit 306 included in the diaphragm drive unit 204 in the photographing lens unit 100A via the mount contacts 209. The memory unit 213 associated with the CPU 212 has a storage function of storing imaging signals from the image capture element 211 and the eye image capture element 219.

The line-of-sight detection circuit 301 performs A/D conversion on the outputs of the eye image capture element 219 in a state in which the eye optical image is formed on the eye image capture element 219 (eye image that is an image obtained by imaging the eyeballs 220, that is, the eye), and transmits the result thereof to the CPU 212. A/D conversion is an abbreviation for “Analogue/Digital conversion”. The CPU 212 extracts feature points necessary for line-of-sight detection from the eye image according to line-of-sight detection processing to be described below, and detects the user's line of sight from the positions of the feature points.

The photometry circuit 302 performs predetermined processing (for example, amplification, logarithmic compression, and A/D conversion) on a signal obtained from the image capture element 211 that also serves as a photometry sensor, such as a brightness signal corresponding to the brightness of the image sensing field, and sends the result thereof to the CPU 212 as image sensing field brightness information.

An automatic focus detection circuit 303 performs the A/D conversion on signals from a plurality of detection elements (a plurality of pixels) included in the image capture element 211 and used for phase-difference detection, and sends the converted signals to the CPU 212. The CPU 212 calculates a distance to the subject corresponding to the respective focus detection points from the signals of the plurality of detection elements. This is a known technique known as imaging plane phase difference AF. AF is an abbreviation for “Auto focus”. In the first embodiment, as an example, it is assumed that there are focus detection points at 180 positions on the imaging plane corresponding to 180 positions in the field of view in the finder (the screen of the display device 214).

A switch SW1 and a switch SW2 are connected to the signal input circuit 304. The switch SW1 is a switch that is turned ON by a first stroke of the release button 101 to start an imaging preparation operation (for example, photometry and distance measuring) of the camera 100. The switch SW2 is a switch that is turned ON by a second stroke of the release button 101 to start an imaging operation. The second stroke is a stroke deeper than the first stroke. ON signals from the switches SW1 and SW2 are input to the signal input circuit 304 and transmitted to the CPU 212. Line-of-sight detection may be started when the switch SW1 is turned ON. It should be noted that the light-source drive circuit 305 drives the light sources 216a and 216b.

Furthermore, the operation members 103, 104, and 105 are also connected to the CPU 212. When the user operates the operation members 103 to 105, the operation members 103 to 105 output operation signals corresponding to the operation from the user to the CPU 212. The CPU 212 performs processing (control) according to the operation signals that have been input from the operation members 103 to 105. For example, the CPU 212 moves a selection frame of the displayed menu according to the operation signal.

### [Configuration Diagram of Image Capturing Apparatus]

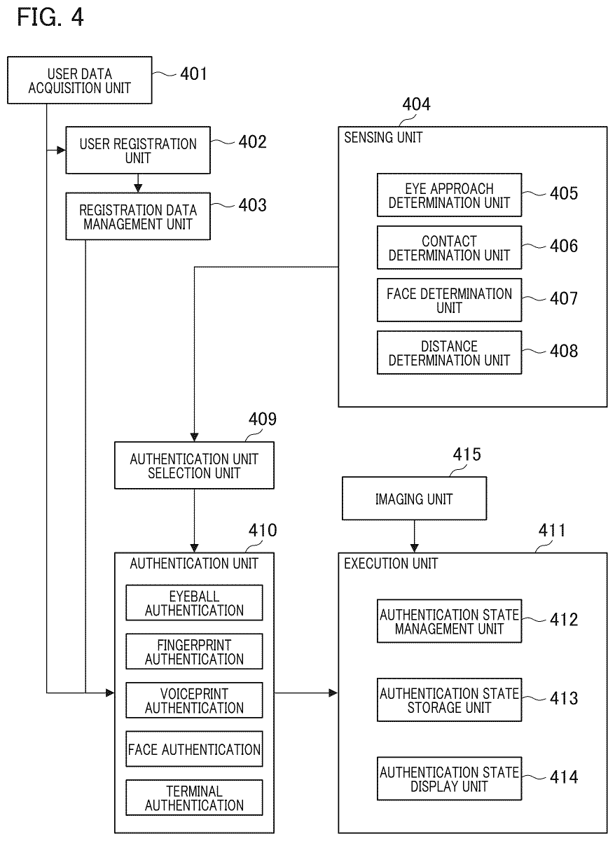

FIG. 4 is a block diagram illustrating a processing method for performing personal authentication of a user of the camera 100. Personal authentication in the present embodiment uses at least one of eyeball authentication, fingerprint authentication, face authentication, voice authentication, and terminal authentication. Hereinafter, an explanation is provided with respect to each component.

A user data acquisition unit 401 acquires user data necessary for various authentication units. In a case in which the authentication unit is used for eyeball authentication, the user data acquisition unit 401 acquires an image of the eyeball 220 of the user looking into the eyepiece lens 102. Specifically, the user data acquisition unit 401 acquires an eye image from the eye image capture element 219 via the line-of-sight detection circuit 301. The user data acquisition unit 401 acquires the eye image by acquiring an eye image signal that is an electrical signal of the eye image.

In a case in which the authentication unit is used for fingerprint authentication, the user data acquisition unit 401 acquires the fingerprint of the user who touches the release button 101. The release button 101 includes a fingerprint sensor. In a case in which the authentication unit is used for facial authentication, the user data acquiring unit 401 acquires the face image of the user that has been captured by the front-facing camera 106. In a case in which the authentication unit is used for voice authentication, the user data acquisition unit 401 acquires the voiceprint of the user from an audio signal that has been converted by the microphone 107.

In a case in which the authentication unit is used for terminal authentication, the user data acquisition unit 401 acquires, for example, a password and the like that have been input by the user in the camera 100. In a case in which the terminal is a smartphone or a smartwatch, the user data acquisition unit 401 acquires identification information and the like unique to the terminal. In a case in which the terminal is an accessory or a card of the camera 100, and the authentication unit is used for an authentication unit in which authentication is performed in a case in which those terminals are in a position close to the camera 100, the user data acquisition unit 401 acquires unique identification information and position information or the like of the accessory or the card.

A registration data management unit 403 holds registration information of a user who uses the camera 100. Specifically, the registration data management unit 403 registers and manages the user by holding the authentication information of the user and the name of the user linked to each other in a memory unit 213 as registration information of the user using the camera 100. In a case in which the authentication unit is used for eyeball authentication, the registration information of the user is, for example, a feature vector of an eye image. In a case in which the authentication unit is used for fingerprint authentication, the authentication information of the user is, for example, a feature vector of a fingerprint. In a case in which the authentication unit is used for face authentication, the authentication information of the user is, for example, a feature vector of a face. In a case in which the authentication unit is used for voice authentication, the authentication information of the user is, for example, a feature vector of a voiceprint. In a case in which the authentication unit is used for password authentication among terminal authentication, the authentication information of the user is, for example, a password. In a case in which the authentication unit is authentication by a smartphone or a smartwatch among terminal authentication, the authentication information of the user is, for example, identification information unique to the smartphone or the smartwatch. In a case in which the authentication unit is authentication by an accessory, a card of the camera 100, or the like among the terminal authentication, the user authentication information is, for example, identification information and position information unique to the accessory or the card.

A user registration unit 402 creates data to be registered in the registration data management unit 403. A sensing unit 404 is configured by an eye approach determination unit 405, a contact determination unit 406, a face determination unit 407, and a distance determination unit 408. The sensing unit 404 is configured by at least any plurality of an eye approach determination unit 405, the contact determination unit 406, the face determination unit 407, and the distance determination unit 408.

Determination results from the eye approach determination unit 405, the contact determination unit 406, the face determination unit 407, and the distance determination unit 408 are examples of a position or state of a photographer. The sensing unit 404 is an example of a sensing unit that senses the position or the state of the photographer. The eye approach determination unit 405 determines whether or not the user is looking into the eyepiece lens 102. The contact determination unit 406 determines whether or not the user is touching the release button 101. The face determination unit 407 determines whether or not the user is behind the camera 100. The distance determination unit 408 acquires a distance from the camera 100 to the terminal possessed by the user, and determines whether or not the distance exceeds a threshold. The eye approach determination unit 405 is an example of an eye approach determination unit that determines whether or not the photographer is looking into the finder, that is, the eyepiece lens 102. The contact determination unit 406 is an example of a contact determination unit that determines whether or not the photographer is touching the camera 100. The face determination unit 407 is an example of a face determination unit that determines whether or not the photographer is behind the camera 100. The distance determination unit 408 is an example of a distance determination unit that determines whether or not the photographer is within a certain range from the camera 100.

An authentication unit selection unit 409 selects one authentication unit from a plurality of usable authentication units. Here, the reason why one authentication unit is selected from the plurality of authentication units is that there exists an authentication unit that cannot be used or is difficult to use depending on the situation of image capturing. Additionally, there is also a user need to indicate that the image was captured by performing authentication with more stringent authentication unit. For example, iris authentication cannot be used if the user is not looking into the finder, and face authentication cannot be used if a face image cannot be acquired. Additionally, in a case in which rapid authentication is desired, time-consuming authentication units are unacceptable. Therefore, selecting an authentication unit according to the situation of image capturing and the request of the user is required. Therefore, in the present embodiment, the eye approach determination unit 405, the contact determination unit 406, the face determination unit 407, and the distance determination unit 408 of the sensing unit 404 determine whether or not the authentication unit during image capture is usable. In the present embodiment, from among the authentication units determined as usable, the authentication unit having the highest authentication accuracy is preferentially selected.

An authentication unit 410 performs a process of authenticating which registered person is capturing an image when the user captures an image. The authentication unit 410 analyzes the user data that has been acquired by the user data acquisition unit 401 and generates a feature vector. For example, in a case in which iris authentication is selected by the authentication unit selection unit 409, a feature vector is generated from the acquired image data of the eye. Furthermore, matching is performed by comparing a template in which data is held in advance by the registration data management unit 403 and the feature vector generated from the acquired user data. As a result of the matching, a similarity score is generated, and an authentication result is output according to the similarity score. This authentication result is referred to as an authentication state. Although in the present embodiment, the authentication processing of the authentication unit 410 has been described as above using biometric authentication as an example, the present disclosure is not limited thereto. For example, in a case in which the acquired user data is identification information or position information unique to a smartphone and a smartwatch, an authentication result is output depending on whether or not the acquired identification information matches the identification information stored in a server or a system. As described above, the authentication unit executed by the authentication unit 410 is any one of the eyeball authentication, the fingerprint authentication, the face authentication, the voice authentication, and the terminal authentication. The eyeball authentication, the fingerprint authentication, the face authentication, the voice authentication, and the terminal authentication are examples of a plurality of authentication methods. The authentication unit 410 is an example of an authentication unit that authenticates a photographer by any one of the plurality of authentication methods. The authentication unit selection unit 409 is an example of an authentication unit selection unit that selects one of a plurality of authentication methods to be used by the authentication unit 410 based on the position or state of the photographer sensed by the sensing unit 404. The process performed by the authentication unit selection unit 409 is an example of an authentication unit selection process of selecting one of a plurality of authentication methods to be used in the authentication process based on the position or state of the photographer sensed in the sensing process.

An execution unit 411 executes the processing according to the authentication state. The execution unit 411 includes an authentication state management unit 412, an authentication state storage unit 413, and an authentication state display unit 414. The authentication state management unit 412 manages an authentication state. The authentication state indicates which authentication unit is selected and whether or not authentication is being performed. The state of whether or not authentication is being performed takes a value of either “authentication in progress” or “unauthenticated”. The authentication state storage unit 413 stores the authentication state. The authentication state display unit 414 displays the authentication state. The execution unit 411 is an example of an execution unit that executes a specific process based on the authentication state of the authentication unit selected by the authentication unit selection unit 409. The authentication state storage unit 413 of the execution unit 411 executes a process of storing information indicating the selected authentication unit, and the authentication accuracy and the ease of authentication of the authentication unit in association with the captured image. The process of storage performed by the authentication state storage unit 413 is an example of a specific process executed based on the authentication state of the authentication unit selected by the authentication unit selection unit 409.

Upon receiving a signal indicating that the user has pressed the release button 101, an imaging unit 415 records an image captured by the image capture element 211 in the memory unit 213. The authentication state storage unit 413 records the authentication state of the authentication state management unit 412 as metadata in association with the image acquired by the imaging unit 415. As a method of recording metadata of an image, there is a method known as C2PA. C2PA is a method of adding, to an image, metadata indicating contents of edition performed on the image in order to authenticate the source, history, and provenance of the image. Accordingly, in the present embodiment, the authentication state and the like may be recorded according to the C2PA. However, the present disclosure may be recorded by other methods. Alternatively, in the present disclosure, an image file and a metadata file may be separately recorded. Alternatively, in the present disclosure, the metadata may be managed in a database. The recording method of metadata in the present disclosure is not limited to these methods.

The authentication state display unit 414 displays the authentication state on the camera based on the authentication state of the authentication state management unit 412. For example, when the authentication state is “authentication in progress”, the authentication state display unit 414 displays “authentication in progress” and the like on the display device 214 and the touch panel (operation member 103). Alternatively, the camera 100 may be configured to include an LED lamp (not illustrated) and the like, and the authentication state display unit 414 may turn on the LED lamp and the like when the authentication state is “authentication in progress”.

### [Selection of Authentication Unit]

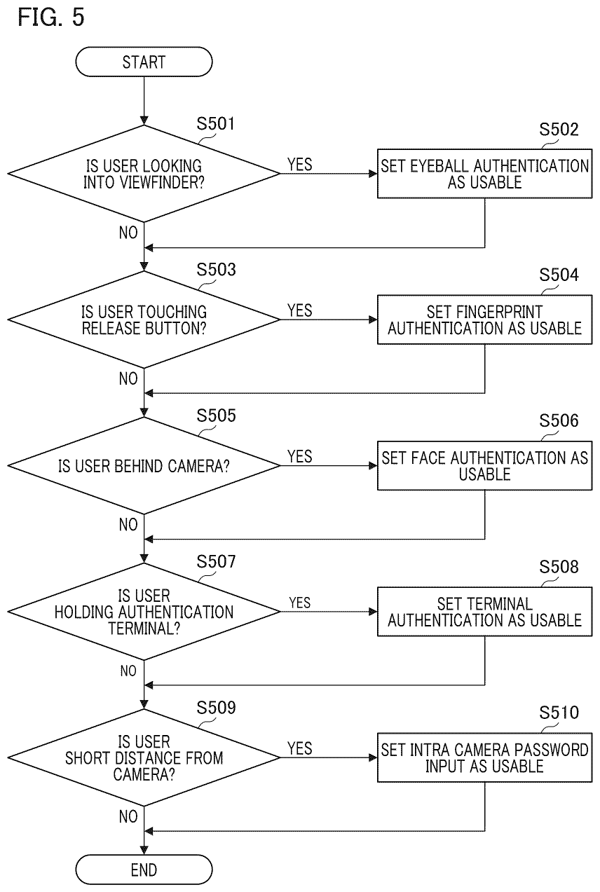

The authentication unit selection processing according to the present embodiment will be explained with reference to the flowchart in FIG. 5. This processing is mainly executed in the CPU 212 by the authentication unit selection unit 409. It is assumed that the processing for selecting an authentication unit is performed by the user immediately before authentication is performed during image capture.

First, the sensing unit 404 determines the usable unit during authentication. Subsequently, from among the authentication units determined as usable, the authentication unit selection unit 409 selects an authentication unit having the highest authentication accuracy. The determination of the usable authentication unit is performed according to the flowchart of FIG. 5.

In step S501, the sensing unit 404 determines whether or not the user is looking into the viewfinder, that is, the eyepiece lens 102, by the proximity sensor 221. In this context, the determination unit need not be a proximity sensor, and may determine whether or not the user is looking into the viewfinder by capturing an eyeball 220 using an eye image capture element 219. In a case in which the sensing unit 404 determines that the user is looking into the viewfinder, the process of step S502 is executed. In a case in which the sensing unit 404 determines that the user is not looking into the viewfinder, the process of step S503 is executed. In step S502, the sensing unit 404 sets eye authentication to be usable.

In step S503, the sensing unit 404 determines whether or not the user is touching the release button 101 by the contact sensor. As a contact sensor, a fingerprint sensor of the release button 101 may be used. In a case in which the sensing unit 404 determines that the user is touching the release button 101, the process of step S504 is executed. In a case in which the sensing unit 404 determines that the user is not touching the release button 101, the process of step S505 is executed. In step S504, the sensing unit 404 sets fingerprint recognition to be usable.

In step S505, the sensing unit 404 determines whether or not the user is on the back surface of the camera 100 by the front-facing camera 106 on the back surface of the camera 100. To be more specific, the front-facing camera 106 acquires an image of the back surface of the camera 100, and a face detector detects the face of a person from the image. In a case in which the face of a person is detected, it is determined that the user is behind the camera 100. In a case in which the sensing unit 404 determines that the user is behind the camera 100, the process of step S506 is executed. In a case in which the sensing unit 404 determines that the user is not behind the camera 100, the process of step S507 is executed. In step S506, the sensing unit 404 sets facial authentication as usable.

In step S507, the sensing unit 404 determines whether or not the user is holding an authentication terminal. Specifically, for example, it is assumed that the authentication terminal is a smartphone, a smartwatch, or an accessory or a card of a camera. Bluetooth (registered trademark) is provided in both the camera 100 and these authentication terminals, and the authentication terminals are pre-registered in the registration data management unit 403. Accordingly, the camera 100 can detect the proximity of the two devices of the camera 100 and the authentication terminal by using Bluetooth, and determines that the user is holding the authentication terminal when the two devices are close to each other. In a case in which the sensing unit 404 determines that the user is holding the authentication terminal, the process of step S508 is executed. In a case in which the sensing unit 404 determines that the user is not holding the authentication terminal, the process of step S509 is executed. In step S508, the sensing unit 404 sets terminal authentication to be usable.

In step S509, the sensing unit 404 determines whether or not the user is at a close distance from the camera 100. As examples of this determination, specifically, two methods can be cited. A first method is a method using the process of step S505 for determining whether or not a user is behind the camera 100 by using the front-facing camera 106 on the back surface of the camera 100. A second method is a method using Bluetooth. The second method is based on the premise that an authentication terminal with Bluetooth is held, and the sensing unit 404 reads the position of the authentication terminal relative to the position of the camera 100 by Bluetooth. In a case in which the position of the authentication terminal is within a predetermined distance from the camera 100, the sensing unit 404 determines that the user is at a short distance from the camera 100. In a case in which the sensing unit 404 determines that the user is at a short distance from the camera 100, the process of step S510 is executed. In a case in which the sensing unit 404 determines that the user is not at a short distance from the camera 100, the process in FIG. 5 is ended. In step S510, the sensing unit 404 sets password input in the camera 100 to be usable.

The above is the flow of the determination of usable authentication units. Subsequently, from among the usable authentication units, the authentication unit selection unit 409 selects the authentication unit having the highest authentication accuracy.

Eyeball authentication is an authentication unit using an eyeball including an iris having a radial pattern that easily identifies an individual. For example, eyeball authentication uses a method of detecting and normalizing the iris from an eye image, and performing matching by calculating a feature map by using a neural network.

The fingerprint authentication is an authentication unit that uses features such as positions and angles of fingerprints, and patterns such as endpoints and branches. For example, in the fingerprint authentication, a method using minutiae matching in which minutiae that are end points and branch points of fingerprint ridges are extracted, the positions, directions, and the like of the minutiae are compared, and it is evaluated whether or not the fingers are the same finger is used.

Face authentication is an authentication unit using facial features such as eyes, nose, mouth, and contour. For example, face authentication uses a method of performing matching by extracting a feature vector by a neural network that has learned distances between feature vectors of faces.

Voice authentication is a method using a feature of a voice and has a characteristic of using time-series data. For example, voice authentication uses a method of identifying a speaker by extracting a speaker expression vector (x-vector) by using a time delay neural network that aggregates time-series voice features.

It should be noted that since these technologies are still being improved, mainstream methods at the time of development need only be selected, and it is not necessary to limit to the methods of these documents.

In the above-described biometric authentication, the priority order is set in descending order of the authentication accuracy with reference to the accuracy of the above-described authentication unit or other adopted methods. Then, the authentication unit selection unit 409 selects an authentication unit having the highest priority among the authentication units determined to be usable in the flow of FIG. 5. At this time, in a case in which no authentication unit is usable, the camera 100 can also authenticate the user using a method other than biometric authentication.

### Modified Example of First Embodiment

[Selection of Other Authentication unit]

In the first embodiment, the authentication unit selection unit 409 selects an authentication unit having the highest authentication accuracy from a plurality of authentication units. However, the user does not necessarily want to select the authentication unit with the highest authentication accuracy. For example, if the user is not aware of the authentication accuracy of each authentication unit, it is difficult for the user to understand which authentication unit will be selected. Therefore, in some cases, it is easier for the user to understand which authentication unit will be selected if the authentication unit is selected based on a predetermined priority.

Additionally, some users may have preferred authentication units, and there may be a case in which users want their preferred authentication unit to be more easily selected. In this case, the user needs to set a priority order for selecting authentication units.

In addition, in a case in which the authentication accuracy is high, there is a possibility that the time required for authentication inside the camera 100 is long. In this case, since there is a possibility that authentication cannot be performed when the user wants to capture images in a hurry, an authentication unit that takes less time is better for the user.

Here, three modified examples will be described: a method of searching in a determined order, a method of selecting a unit with less effort for authentication, and a method in which the user specifies the priority order of authentication units.

In the modified example 1-1, which is a first modified example, a method of searching in a predetermined order will be explained. The modified example 1-1 is a method in which there is a predetermined order for selecting authentication units. The method determines whether or not an authentication unit is usable according to that order, and if a usable authentication unit is found, the search stops and that authentication unit is selected. For example, in the flow of FIG. 5, it is determined whether or not these authentication units are usable in the order of the eyeball authentication, the fingerprint authentication, the face authentication, the terminal authentication, and the password input in the camera 100. Accordingly, in this case, the authentication unit selection unit 409 selects the eyeball authentication when the eyeball authentication is usable. Additionally, when the eyeball authentication is not usable and fingerprint authentication is usable, the authentication unit selection unit 409 selects the fingerprint authentication. When eyeball authentication and fingerprint authentication are not usable and face authentication is usable, the authentication unit selection unit 409 selects the face authentication. Additionally, the authentication unit selection unit 409 selects the terminal authentication when the eyeball authentication, fingerprint authentication, and face authentication are not usable and terminal authentication is usable. Note that even if password input in the camera 100 is usable, the password input is not selected because face authentication or terminal authentication is also usable in this case.

In the modified example 1-2, which is a second modified example, a method of selecting a unit that takes less time and effort for authentication will be explained. In a method that prioritizes ease of authentication, the easiest authentication unit is selected from among usable authentication units. The ease of authentication is defined by the number of actions required by the photographer during authentication and the time taken for authentication. The fewer the number of actions, and the shorter the time required for authentication, the authentication is determined to be easier.

In eye authentication, the user needs to perform the action of looking into the eyepiece lens 102 that serves as a finder. In fingerprint authentication, the user needs to perform the action of touching the release button 101. In face recognition, the user needs to be positioned so that the face is captured by the front-facing camera 106. In voice authentication, the user needs to speak into the microphone 107 so that the voice of the user can be distinguished from ambient noise. In terminal authentication via the password input in the camera 100, the user needs to perform the action of operating the camera 100 to input the password, which takes time and effort. The same applies to terminal authentication via a smartphone and a smartwatch, which requires the user to perform the action of operating the terminal, which takes time and effort. A method of performing authentication in a case in which an accessory, a card, and the camera 100 are within a certain distance is very simple because authentication can be performed simply by approaching the camera if the user holds the accessory or the card.

Additionally, each biometric authentication has different authentication accuracy and processing time vary depending on the algorithm. In general, the higher the authentication accuracy, the longer the processing time, and the lower the authentication accuracy, the shorter the processing time. Additionally, when the robustness is low, it is difficult to perform authentication under a poor environment, and the time required for authentication becomes long. For example, in face authentication, in a case in which a face image to be compared is an image captured under a dark environment and a face image registered in the registration data management unit 403 is an image captured under a bright environment, authentication may not be performed or may take time due to the difference. However, in the case of face authentication that is highly robust and resistant to such environmental fluctuations, there is a high possibility that authentication will succeed immediately. In fingerprint authentication, robustness can be considered high if authentication is possible, for example, even if there is an injury to the fingertip.

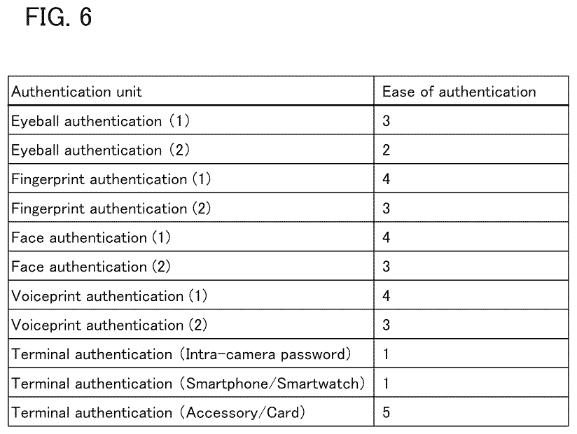

FIG. 6 is a table in which the ease of authentication is quantified for each authentication unit based on the above-described concept. The camera 100 includes two types of biometric authentication units having different robustness and processing times. There are two types of authentication units, that is, an authentication unit with high robustness and short processing time, that is, with a high ease-of-authentication value, and an authentication unit with strict authentication, low robustness, and long processing time, that is, with a low numerical value of the ease of authentication. As shown in FIG. 6, the eyeball authentication includes two types of eyeball authentication of (1) eyeball authentication with a high ease-of-authentication value and (2) eyeball authentication with a low ease-of-authentication value. Additionally, fingerprint authentication has two types of fingerprint authentication of (1) fingerprint authentication with a high ease-of-authentication value and (2) fingerprint authentication with a low ease-of-authentication value. Additionally, there are two types of face authentication of (1) face authentication with a high ease-of-authentication value and (2) face authentication with a low ease-of-authentication value. Additionally, there are two types of voiceprint authentication of (1) voiceprint authentication with a high ease-of-authentication value and (2) voiceprint authentication with a low ease-of-authentication value.

The authentication unit selection unit 409 selects the authentication unit to be used by referring to the ease of authentication of each authentication unit, according to settings such as the numerical value of the ease of authentication to be selected. The authentication unit selection unit 409 may select the authentication unit to be used with reference to the ease of authentication of each authentication unit, according to settings such as whether processing speed or authentication accuracy is prioritized.

Although, in the present modified example, from the above viewpoint, the numerical value of the ease of authentication as shown in FIG. 6 is set in each authentication unit, this is just an example and may change depending on technological advancements or other factors.

In the modified example 1-3, which is the third modified example, a method in which the user sets the priority order of the authentication unit will be explained. This is a method in which the authentication unit selection unit 409 selects an authentication unit with the highest priority that has been set by the user from among usable authentication units. In this manner, the user can preferentially use preferred authentication units. Note that in a case in which the user does not use the authentication function, the user can turn off the authentication function.

The above is modified examples of the method of selecting the authentication unit. Note that the method of selecting the authentication unit is not limited to these, and for example, criteria may be set using a combination of authentication accuracy and ease-of-authentication values.

The authentication accuracy and the ease of authentication are managed together with the authentication state by the authentication state management unit 412. Additionally, in the authentication state storage unit 413, the authentication accuracy and ease of authentication are recorded as metadata together with the authentication state of the authentication state management unit 412, associated with the image acquired by the imaging unit 415.

### Second Embodiment

### [Two Stage Authentication]

In the first embodiment, the personal authentication processing in the camera 100 is executed by one-stage authentication. In contrast, to enhance security, a method of performing authentication in a plurality of stages is also conceivable. In the present embodiment, a case in which the camera 100 uses two-stage authentication will be explained. In the two-stage authentication, it is assumed that the first authentication is performed before the user captures an image with the camera 100, and the second authentication is performed at the time of image capturing.

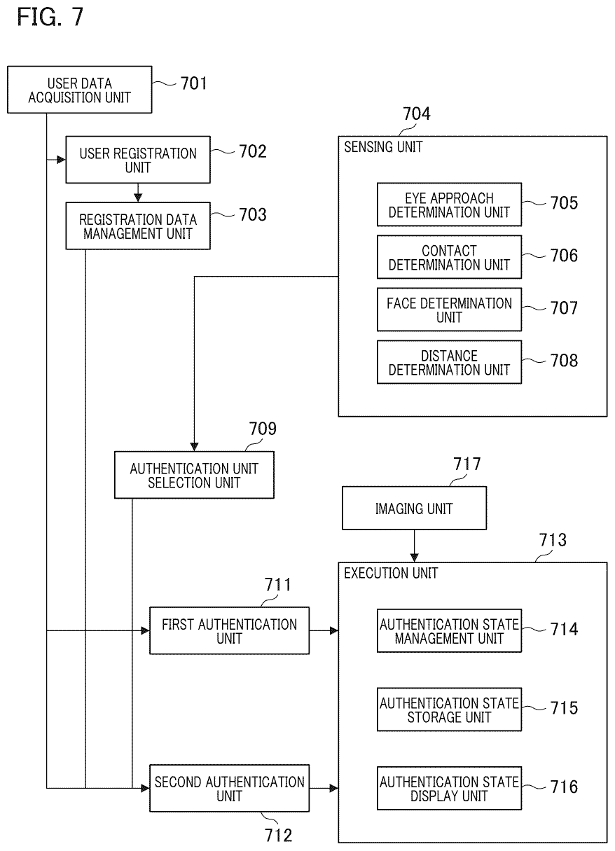

FIG. 7 is a diagram showing the functional configuration of the camera 100 according to the second embodiment. Detailed explanation of the configuration similar to the configuration according to the first embodiment will be omitted. A user data acquisition unit 701 according to the second embodiment is similar to the user data acquisition unit 401 according to the first embodiment. A user registration unit 702 according to the second embodiment is similar to the user registration unit 402 according to the first embodiment. A registration data management unit 703 according to the second embodiment is similar to the registration data management unit 403 according to the first embodiment. A sensing unit 704 according to the second embodiment is similar to the sensing unit 404 according to the first embodiment. An eye approach determination unit 705 according to the second embodiment is similar to the eye approach determination unit 405 according to the first embodiment. A contact determination unit 706 according to the second embodiment is similar to the contact determination unit 406 according to the first embodiment. A face determination unit 707 according to the second embodiment is similar to the face determination unit 407 according to the first embodiment. A distance determination unit 708 according to the second embodiment is similar to the distance determination unit 408 according to the first embodiment. An imaging unit 717 according to the second embodiment is similar to the imaging unit 415 according to the first embodiment.

Additionally, the camera 100 according to the second embodiment includes two authentication units of a first authentication unit 711 and a second authentication unit 712 in place of an authentication unit 410 according to the first embodiment in order to perform authentication in two stages. Although an execution unit 713 of the second embodiment is basically similar to the execution unit 411 of the first embodiment, it is different in that it corresponds to the two authentication units of the first authentication unit 711 and the second authentication unit 712. That is, an authentication state management unit 714 corresponding to the authentication state management unit 412 manages the respective authentication states of the first authentication unit 711 and the second authentication unit 712. Additionally, an authentication state storage unit 715 corresponding to the authentication state storage unit 413 stores the authentication states of the first authentication unit 711 and the second authentication unit 712. Additionally, an authentication state display unit 716 corresponding to the authentication state display unit 414 displays the authentication state of each of the first authentication unit 711 and the second authentication unit 712.

An authentication unit selection unit 709 selects an authentication unit to be executed by each of the first authentication unit 711 and the second authentication unit 712 from among a plurality of usable authentication units by a selection method similar to that of the authentication unit selection unit 409 of the first embodiment. The first authentication unit 711 performs first authentication. The second authentication unit 712 performs second authentication.

In general, to avoid misrecognition of an unrelated person as a registered user, it is necessary to select a strict authentication unit having a low unauthorized acceptance rate, which indicates a probability of erroneously accepting authentication information of the other person as authentication information of the registered user. However, the strict authentication unit is not suitable for authentication during image capture because it has a disadvantage of low usability such as the need for still image capture or a long time. Therefore, in the present embodiment, first, the first authentication unit 711 performs authentication using a highly accurate authentication unit before image capture. Next, during image capturing, a robust authentication unit that is resistant to environmental fluctuations or a fast authentication unit that can be completed in a short time is implemented by selecting using the second authentication unit 712. In the present embodiment, both accuracy of authentication and usability are achieved by performing different types of authentications in a plurality of stages in this manner.

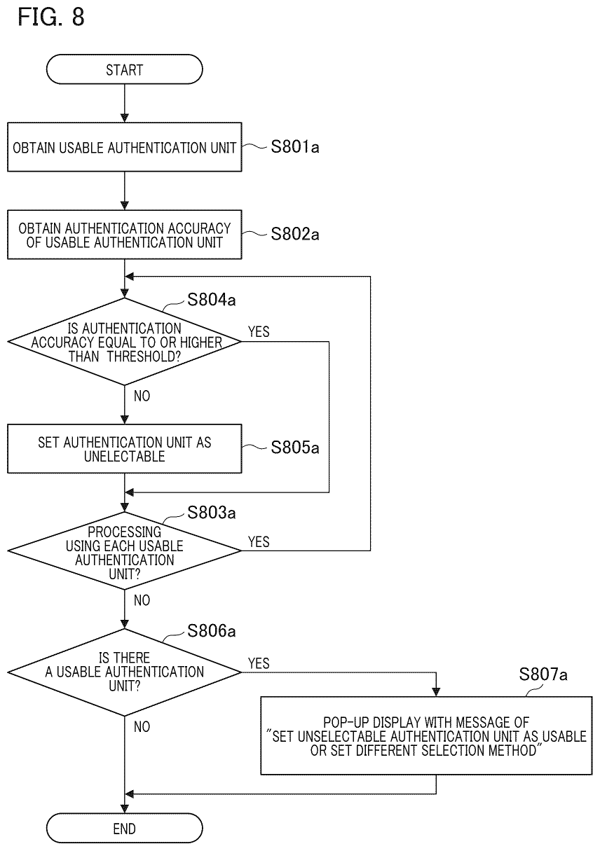

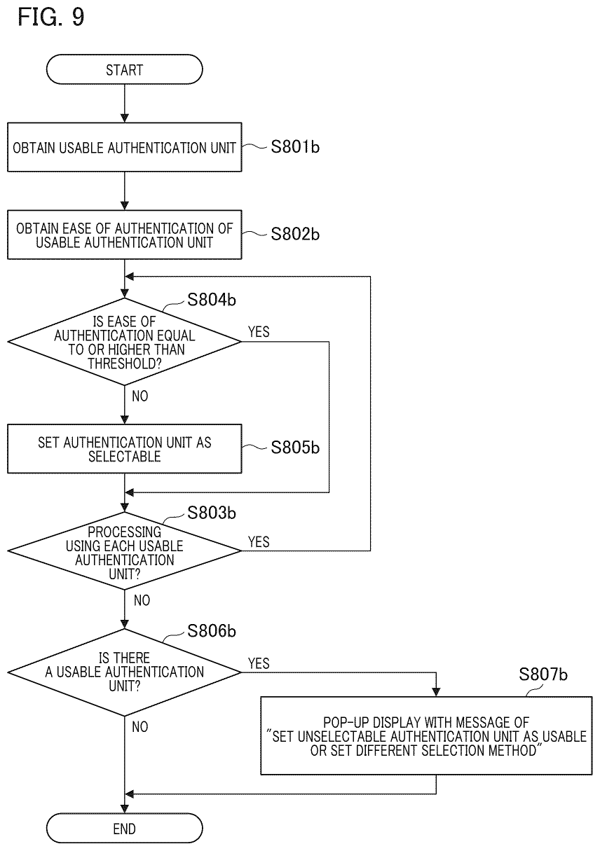

Next, the process flow of selecting an authentication unit by the authentication unit selection unit 709 will be explained. In FIG. 8 and FIG. 9, flowcharts of main processing according to the second embodiment are illustrated. In the examples as illustrated in FIG. 8 and FIG. 9, the authentication unit selection unit 709 selects an authentication unit with high authentication accuracy as an authentication unit that is executed by the first authentication unit 711, and selects an authentication unit with low authentication accuracy but high usability as an authentication unit that is executed by the second authentication unit 712. FIG. 8 illustrates a process of selecting the authentication unit for the first authentication unit 711, and FIG. 9 illustrates a process of selecting the authentication unit for the second authentication unit 712.

First, the process for selecting the authentication unit to be used by the first authentication unit 711 will be explained with reference to FIG. 8. In step S801a, the authentication unit selection unit 709 acquires the determination result from the sensing unit 704, thereby obtaining the usable authentication unit, that is, information indicating which authentication unit is usable. The acquisition of the usable authentication unit follows the method of the first embodiment.

In step S802a, the authentication unit selection unit 709 acquires the authentication accuracy of the usable authentication unit. As a method of acquiring the authentication accuracy, for example, a table in which the authentication accuracy for each authentication unit is set is prepared, and the authentication accuracy is acquired from the table. Note that, here, the high authentication accuracy indicates a low unauthorized acceptance rate.

In step S803a, the authentication unit selection unit 709 repeats the processes of steps S804a and S805a for each usable authentication unit acquired in step S801a, until the processes of steps S804a and S805a are completed.

In step S804a, the authentication unit selection unit 709 determines whether or not the authentication accuracy of the usable authentication unit acquired in step S802a is equal to or greater than a threshold. Here, for the authentication unit used by the first authentication unit 711, the threshold for determination is set relatively high so that an authentication unit with high authentication accuracy is selected. In a case in which the authentication unit selection unit 709 determines that the authentication accuracy is equal to or greater than the threshold, that authentication unit remains usable, and the process for the next authentication unit among the usable authentication unit obtained in step S801a is executed. In a case in which the authentication unit selection unit 709 determines that the authentication accuracy is not equal to or greater than the threshold, the process of step S805a is executed. In step S805a, the authentication unit selection unit 709 sets the authentication unit as unusable, that is, as unselectable. When the processes of step S801a and step S804a are completed for all the usable authentication units acquired in step S805a, the process of the step S806a is executed.

In step S806a, the authentication unit selection unit 709 determines whether or not there is an usable authentication unit. In a case in which the authentication unit selection unit 709 determines that a usable authentication unit is present, the process of FIG. 8 ends. The authentication unit selection unit 709 selects an authentication unit from the usable authentication units according to the selection method of the first embodiment. In a case in which the authentication unit selection unit 709 determines that there is no usable authentication unit, the process of step S807a is executed.

In step S807a, the authentication unit selection unit 709 displays a pop-up on the touch panel 103 on the back surface of the camera 100 with the message “Set an unselectable authentication unit as usable or set a different selection method”.

Next, a process of selecting the authentication unit to be used by the second authentication unit 712 will be explained with reference to FIG. 9. In step S801b, the authentication unit selection unit 709 acquires a usable authentication unit, that is, information indicating which authentication units are usable by obtaining the determination result from the sensing unit 704. The acquisition of the usable authentication unit follows the method of the first embodiment.

In step S802b, the authentication unit selection unit 709 acquires the numerical value of the ease of authentication of the usable authentication unit. As a method of acquiring the numerical value for the ease of authentication, for example, a table in which the numerical value of the ease of authentication is set for each authentication unit, as illustrated in FIG. 6 is prepared, and the numerical value of the ease of authentication is acquired from the table.

In step S803b, the authentication unit selection unit 709 repeats the processes of steps S804b and S805b for each usable authentication unit acquired in step S801b, until the processes of steps S804b and S805b are completed.

In step S804b, the authentication unit selection unit 709 determines whether or not the ease-of-authentication value for the usable authentication unit acquired in step S802b is equal to or greater than a threshold. Here, for the authentication unit used by the second authentication unit 712, the threshold for determination is set higher so that an authentication unit that is easy to authenticate is selected. Needless to say, the thresholds compared to the ease-of-authentication value in the process of step S804b are different from the thresholds compared to the authentication accuracy in the process of step S804a. In the case in which the authentication unit selection unit 709 determines that the ease-of-authentication value is equal to or greater than the threshold, the authentication unit remains usable, and the process for the next authentication unit among the usable authentication units obtained in step S801b is executed. In a case in which the authentication unit selection unit 709 determines that the ease-of-authentication value is not equal to or greater than the threshold, the process of step S805b is executed. In step S805b, the authentication unit selection unit 709 sets the authentication unit as unusable, that is, as unselectable. In a case in which the processes of step S801b and step S804b are completed for all the usable authentication units obtained in step S805b, the process of step S806b is executed.

In step S806b, the authentication unit selection unit 709 determines whether or not a usable authentication unit is present. In a case in which the authentication unit selection unit 709 determines that a usable authentication unit is present, the process of FIG. 9 ends. The authentication unit selection unit 709 selects an authentication unit from the usable authentication units according to the selection method of the first embodiment. In a case in which the authentication unit selection unit 709 determines that any usable authentication unit is not present, the process of step S807b is executed.

In step S807b, the authentication unit selection unit 709 displays a pop-up on the touch panel 103 on the back surface of the camera 100 with the message “Set an unselectable authentication unit as usable or set a different selecting method”.

The above is the flow of the process for selecting the authentication unit, where the authentication unit to be used by the first authentication unit 711 prioritizes high authentication accuracy, and the authentication unit to be used by the second authentication unit 712 prioritizes ease of authentication, that is, usability.

### Modified Example of Second Embodiment

[Selection of Combination of Authentication unit of First Authentication and Second Authentication]

For a selection method of the authentication unit by the first authentication unit 711 and the second authentication unit 712, for example, the following four modified examples are exemplified in addition to the above.

A selection method of a modified example 2-1, which is the first modification, is a method in which the authentication unit to be used by the first authentication unit 711 and the authentication unit to be used by the second authentication unit 712 are different authentication units. Although a method of performing two-stage authentication with the same authentication unit has one authentication element, a method of performing two-stage authentication with different authentication units has two authentication elements, thereby increasing security.

A selection method of a modified example 2-2, which is the second modified example, is a method in which the most accurate authentication unit among the usable authentication units is selected to be used for both the first authentication unit 711 and the second authentication unit 712. As a result, security is enhanced.

A selection method of a modified example 2-3, which is the third modified example, is a method in which the authentication unit with the highest authentication accuracy among the usable authentication units is selected to be used for both the first authentication unit 711 and the second authentication unit 712. As a result, two-stage authentication with high convenience for the user is achieved.

A selection method of a modified example 2-4, which is the fourth modification, is a method in which the user sets the priority order of the authentication unit. This method is a method of selecting the authentication unit having the highest priority set by the user from among the usable authentication units so as to be used by the first authentication unit 711 and the second authentication unit 712. This is performed for each of the first authentication unit 711 and the second authentication unit 712.

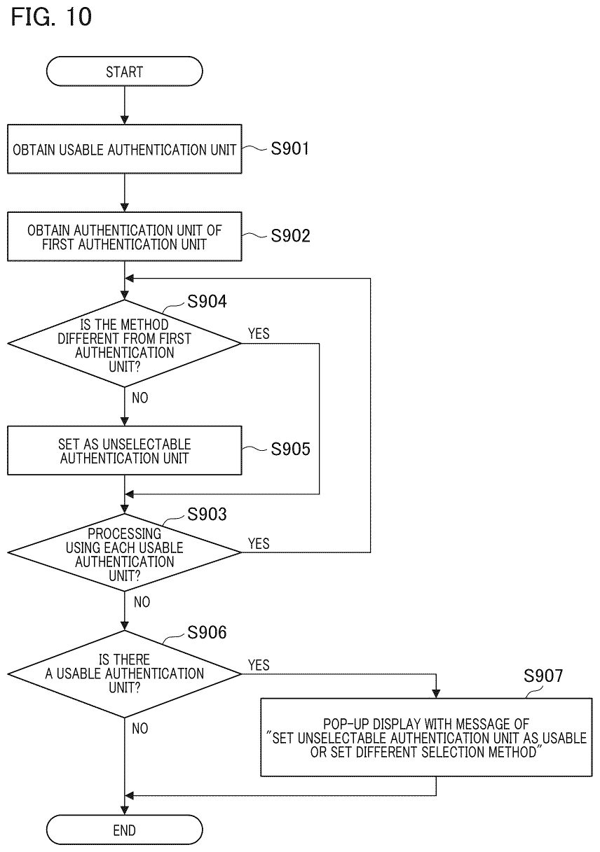

Hereinafter, the processing of each modified example will be further explained. First, an explanation will be given of the flow of the process in the selection method of the modified example 2-1, where the authentication unit to be used by the first authentication unit 711 and the authentication unit to be used by the second authentication unit 712 are different authentication units. The selection of the authentication unit to be used by the first authentication unit 711 follows the first embodiment. The selection of the authentication unit to be used by the second authentication unit 712 will be described with reference to FIG. 10.

FIG. 10 illustrates the flow of process for selecting the authentication unit to be used by the second authentication unit 712. In step S901, the authentication unit selection unit 709 acquires the usable authentication unit, that is, information indicating which authentication unit is usable by acquiring the determination result from the sensing unit 704. The acquisition of the usable authentication unit follows the method of the first embodiment.

In step S902, the authentication unit selection unit 709 acquires the authentication unit in the first authentication unit 711, that is, the information regarding the authentication unit to be used by the first authentication unit 711, from the authentication state management unit 714.

In step S903, the authentication unit selection unit 709 repeats the processes of steps S904 and S905 for each usable authentication unit acquired in step S901, until the processes of steps S904 and S905 are completed.

In step S904, the authentication unit selection unit 709 determines whether or not the usable authentication unit is a different authentication unit from the authentication unit to be used by the first authentication unit 711 acquired in step S902. In the case in which the authentication unit selection unit 709 determines that the usable authentication unit is the same as the authentication unit to be used as the authentication unit of the first authentication unit 711 acquired in step S902, the process of the step S905 is executed. In step S905, the authentication unit selection unit 709 sets the usable authentication unit as unusable, that is, as unselectable. In the case in which the authentication unit selection unit 709 determines the usable authentication unit is different from the authentication unit used by the first authentication unit 711, the usable authentication unit remains usable, and the process for the next authentication unit among the usable authentication units acquired in step S901 is executed. In a case in which the processes of step S901 and step S904 are completed for all the usable authentication units acquired in step S905, the process of step S906 is executed.

In step S906, the authentication unit selection unit 709 determines whether or not a usable authentication unit is present. In a case in which the authentication unit selection unit 709 determines that a usable authentication unit is present, the process of FIG. 10 is ended. The authentication unit selection unit 709 selects an authentication unit from the usable authentication units according to the selection method of the first embodiment. In a case in which the authentication unit selection unit 709 determines that a usable authentication unit is not present, the process of step S907 is executed.

In step S907, the authentication unit selection unit 709 displays a pop-up on the touch panel 103 on the back surface of the camera 100 with a message “Set an unselectable authentication unit as usable or set a different selection method”.

Next, a method in which the authentication unit having the highest authentication accuracy among the usable authentication units is selected to be used for both the first authentication unit 711 and the second authentication unit 712, which is the selection method of the modified example 2-2, will be explained. The selection method of the modification 2-2 is implemented by applying the method of selecting the unit having the highest authentication accuracy in the first embodiment to both the authentication unit of the first authentication unit 711 and the authentication unit of the second authentication unit 712.

Next, a method in which the easiest authentication unit among the usable authentication units is selected to be used for both the first authentication unit 711 and the second authentication unit 712, which is the selection method of the modified example 2-3, will be explained. The selection method of the modified example 2-3 is implemented by applying the method of selecting the method that is easiest to authenticate in the modified example 1-2 of the first embodiment to both of the authentication units of the first authentication unit 711 and the second authentication unit 712.

### Third Embodiment

### [Invalidation of Authentication]

In a case in which the apparatus of the present disclosure has a plurality of authentication units, there is a possibility that spoofing is performed in each of authentication units. As a result, the probability of permitting spoofing is higher than that in the case in which only one authentication unit is possessed. Additionally, in the case in which authentication success is automatically continued after authentication has succeeded, there is a possibility that another person uses the apparatus when authentication success is being continued. In the third embodiment, a configuration including a mechanism for detecting use by unauthorized user and a mechanism for invalidating an authentication state will be explained in order to address the above. By using this mechanism, it is possible to improve the reliability of personal authentication of the apparatus.

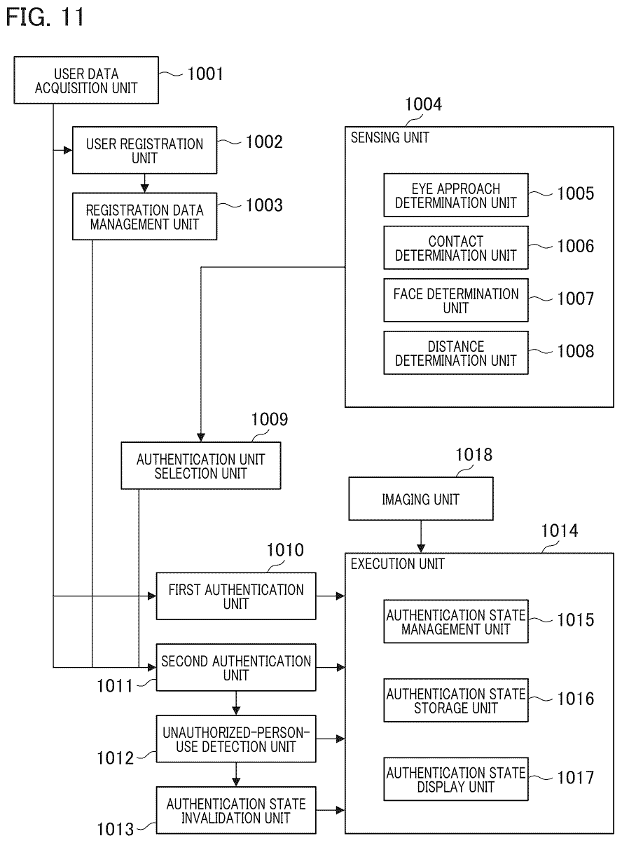

FIG. 11 is a diagram showing the functional configuration of the camera 100 according to the third embodiment. Detailed explanation of the configuration that is similar to the configuration according to the second embodiment will be omitted. A user data acquisition unit 1001 according to the third embodiment is similar to the user data acquisition unit 701 according to the second embodiment. A user registration unit 1002 according to the third embodiment is similar to the user registration unit 702 according to the second embodiment. A registration data management unit 1003 according to the third embodiment is similar to the registration data management unit 703 according to the second embodiment. A sensing unit 1004 according to the third embodiment is similar to the sensing unit 704 according to the second embodiment. An eye approach determination unit 1005 according to the third embodiment is similar to the eye approach determination unit 705 according to the second embodiment. A contact determination unit 1006 according to the third embodiment is similar to the contact determination unit 706 according to the second embodiment. A face determination unit 1007 according to the third embodiment is similar to the face determination unit 707 according to the second embodiment. A distance determination unit 1008 according to the third embodiment is similar to the distance determination unit 708 according to the second embodiment. A first authentication unit 1010 according to the third embodiment is similar to the first authentication unit 711 according to the second embodiment. A second authentication unit 1011 according to the third embodiment is similar to the second authentication unit 712 according to the second embodiment. An imaging unit 1018 according to the third embodiment is similar to the imaging unit 717 according to the second embodiment.

An unauthorized use detection unit 1012 detects that a person different from the person authenticated by the first authentication unit 1010 (unauthorized person) is performing image capture using the camera 100. Whether or not the photographer is an unauthorized person is determined based on the tendency of the authentication state in the second authentication unit 1011. Specifically, in the authentication unit selection unit 1009, among the usable authentication units that are different from the authentication unit selected for the first authentication unit 1010, all usable authentication units are selected as the authentication units for the second authentication unit 1011. Then, the second authentication unit 1011 performs all the selected usable authentication units. The unauthorized use detection unit 1012 determines whether or not the person authenticated by each authentication unit in the second authentication unit 1011 is the same person as the person authenticated by the first authentication unit 1010. At this time, the unauthorized use detection unit 1012 detects unauthorized use in a case in which the unauthorized use detection unit 1012 determines that more than half of the authentication units in the second authentication unit 1011 determine that the person is not the same person as the person authenticated by the first authentication unit. In a case in which there was only one usable authentication unit in the second authentication unit 1011, the unauthorized use detection unit 1012 detects unauthorized use when authentication failure by the second authentication unit 1011 continues for a predetermined number of times or more, or when an authentication score is significantly low. Note that the method of determining whether or not the person is an unauthorized person is not limited thereto. The unauthorized use detection unit 1012 is an example of an unauthorized use detection unit that detects use by an unauthorized person by comparing the authentication result of the first authentication unit 1010 and the authentication result of the second authentication unit 1011.

When the authentication performed by the first authentication unit 1010, that is, the first authentication is successful, an authentication state invalidation unit 1013 determines whether or not the authentication state is to be invalidated. There are several methods for determining invalidation. Here, an explanation will be given by providing two examples of invalidation determining methods.

A first invalidation determining method is a method based on detection of use by an unauthorized person. Specifically, the authentication state invalidation unit 1013 invalidates the authentication when the use by an unauthorized person is detected by the unauthorized use detection unit 1012.

The second invalidation determining methods is a method based on an elapsed time from the success of the first authentication performed by the first authentication unit 1010. For example, the authentication state invalidation unit 1013 invalidates the authentication state when an elapsed time from the success of the first authentication exceeds a predetermined lifetime. In a case in which the second authentication is successful when the first authentication is valid, the lifetime is extended. At this time, since in a case in which the authentication units of the first and second authentication are different, the reliability of the authentication is higher, the lifetime is extended. Additionally, in a case in which there are a plurality of authentication units that can be used in the second authentication, it is possible to further extend the lifetime by performing all the usable authentication units.

An authentication state management unit 1015 also manages the detection result of the unauthorized use detection unit 1012 in addition to the information of the authentication unit selected by the authentication unit selection unit 1009 and the information indicating whether or not authentication is being performed. Specifically, the authentication state management unit 1015 holds a value of either “Unauthorized use detected” or “No unauthorized use detected” indicating whether or not unauthorized use has been detected. In a case in which the authentication state is invalidated by the authentication state invalidating unit 1013, the authentication state management unit 1015 updates the authentication state to “unauthenticated”.

An authentication state storage unit 1016 records, as metadata, the presence or absence of unauthorized use in addition to the authentication unit selected by the authentication unit selection unit 1009 and information indicating whether or not authentication is being performed, in association with an image captured by the imaging unit 1018.

An authentication state display unit 1017 displays the authentication state on the camera 100 based on the authentication state of the authentication state management unit 1015. For example, in a case in which the unauthorized use detection unit 1012 detects the unauthorized use, the authentication state display unit 1017 displays “Unauthorized use detected” and the like on the display device 214 or the touch panel (operation member 103).

### Others

Although the embodiments have been described above in detail, the present disclosure is not limited to the embodiments as described above, and can be appropriately modified without departing from the gist of the present disclosure.

The present disclosure can be embodied, for example, as a system, device, method, program, or storage medium. Specifically, the present disclosure may be applied to a system configured by a plurality of devices or may be applied to an apparatus composed of a single device.

Additionally, the present disclosure is also realized by executing the following processes. That is, the processing is a process in which software (program) for realizing the function of the above-described embodiment is supplied to a system or apparatus via a network or various storage media, and a computer (or CPU, MPU, and the like) of the system or apparatus reads out and executes the program.

### OTHER EMBODIMENTS

The present disclosure can also be realized by a process in which a program that realizes one or more functions of the embodiments as described above is supplied to a system or an apparatus via a network or a storage medium, and one or more processors in a computer of the system or the apparatus read out and execute the program. The present disclosure can also be realized by a circuit (for example, an ASIC) that realizes one or more functions.

Although the preferred embodiments of the present disclosure have been described above, the present disclosure is not limited to these embodiments, and various modifications and changes can be made within the scope of the gist thereof. While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions. This application claims the benefit of Japanese Patent Application No. 2024-096247, filed Jun. 13, 2024, which is hereby incorporated by reference herein in its entirety.

What is claimed is:

1. An image capturing apparatus comprising:
a sensing unit that senses a position or a state of a photographer;
an authentication unit that authenticates the photographer by any one of a plurality of authentication methods each having at least one authentication accuracy;
an authentication unit selection unit that selects any one of the plurality of authentication methods to be used by the authentication unit based on a position or a state of the photographer sensed by the sensing unit; and
an execution unit that execute a specific process based on an authentication state of an authentication method selected by the authentication unit selection unit.

2. The image capturing apparatus according to claim 1, wherein the sensing unit comprises at least one of
an eye approach determination unit that determines whether or not a photographer is looking into a finder;
a contact determination unit that determines whether or not a photographer is touching a camera;
a face determination unit that determines whether or not a photographer is behind a camera; and
a distance determination unit that determines whether or not a photographer is within a certain range from a camera.

3. The image capturing apparatus according to claim 1, wherein when any one of the plurality of authentication methods is selected by the authentication unit selection unit, a method having a highest authentication accuracy from among usable methods of the plurality of authentication methods is selected.

4. The image capturing apparatus according to claim 1, wherein each of the plurality of authentication methods has at least one ease-of-authentication value.

5. The image capturing apparatus according to claim 1, wherein in a case in which any one of the plurality of authentication methods is selected by the authentication unit selection unit, a method having a highest numerical value of ease of authentication from among usable methods of the plurality of authentication methods is selected.

6. The image capturing apparatus according to claim 1, wherein the execution unit executes a process of storing information indicating the selected authentication method and the authentication accuracy and the ease of authentication of the authentication method in association with the captured image.

7. The image capturing apparatus according to claim 1,
wherein the authentication unit comprises a first authentication unit and a second authentication unit, and
wherein the authentication unit selection unit selects any one of the plurality of authentication methods to be used by the first authentication unit, and selects any one of the plurality of authentication methods to be used by the second authentication unit.

8. The image capturing apparatus according to claim 1, wherein an authentication accuracy of a method used by the first authentication unit among the plurality of authentication methods is higher than authentication accuracy of a method used by the second authentication unit among the plurality of authentication methods.

9. The image capturing apparatus according to claim 8, wherein a method used by the first authentication unit among the plurality of authentication methods is different from a method used by the second authentication unit among the plurality of authentication methods.

10. The image capturing apparatus according to claim 8,
wherein a method used by the first authentication unit among the plurality of authentication methods has high authentication accuracy, and
wherein, among the plurality of authentication methods, a method used by the second authentication unit has a high ease-of-authentication value.

11. The image capturing apparatus according to claim 8,
wherein the authentication unit selection unit selects a plurality of methods as a method to be used by the second authentication unit from among the plurality of authentication methods, and
wherein an unauthorized-use-detection unit that detects unauthorized-use by comparing an authentication result of the first authentication unit and an authentication result of the second authentication unit is further included.

12. A control method of an image capturing apparatus comprising:
sensing a position or a state of a photographer;
authenticating the photographer by any one of a plurality of authentication methods each having at least one authentication accuracy;
selecting any one of the plurality of authentication methods to be used in the authenticating based on a position or a state of the photographer sensed in the sensing; and
executing a specific process based on an authentication state of an authentication method selected in the authenticating.

13. A non-transitory computer-readable storage medium configured to store a computer program comprising instructions for executing following processes:
sensing a position or a state of a photographer;
authenticating the photographer by any one of a plurality of authentication methods each having at least one authentication accuracy;
selecting any one of the plurality of authentication methods to be used by the authentication unit based on a position or a state of the photographer sensed by the sensing unit; and
executing a specific process based on an authentication state of an authentication method selected by the authentication unit selection unit.
